(19) United States
(12) Patent Application Publication
(10) Pub. No.: US 2024/0109687 A1
(43) Pub. Date: Apr. 4, 2024

(54) RETENTION SYSTEM FOR A SECURITY SCREENING TRAY

(71) Applicant: Cory James Turner, Chichester, NH (US)

(72) Inventor: Cory James Turner, Chichester, NH (US)

(21) Appl. No.: 18/521,406

(22) Filed: Nov. 28, 2023

Related U.S. Application Data
(60) Provisional application No. 63/411,477, filed on Sep. 29, 2022.

(51) Int. Cl. B65D 25/10; B65D 1/34

(52) U.S. Cl. CPC B65D 25/102; B65D 1/34

(57) ABSTRACT

A retention system of a security screening tray is provided. The retention system embodies a netting that is fixed to a periphery of an opening of the security screening tray. The netting may be attached, by way of attachment points, on only two sides of the other rectangular perimeter of the opening.

### CROSS-REFERENCE TO RELATED APPLICATION

This application claims the benefit of priority of U.S. provisional application No. 63/411,477, filed 29 Sep. 2022, the contents of which are herein incorporated by reference.

### BACKGROUND OF THE INVENTION

The present invention relates to security screening trays and, more particularly, a retention system for a security tray, wherein the retention system retains the security screening tray's items during baggage screening.

In airport passenger security screening, travelers are screened by metal detectors and/or millimeter wave scanners, while their carry-on baggage is screened by the Transportation Security Administration (TSA). The carry-on baggage screening process includes the traveler placing their belongings in one or more security screening trays at security checks. The security screening tray then is typically placed on a conveyor system of some kind that carries the security screening tray underneath or through a security screening device, such as an x-ray. Importantly, x-ray machines, and similar devices used for screening purposes typically have lead curtains to contain any radiation produced, these curtains can dislodge items and goods from security screen trays as they pass therethrough.

A similar monitoring system is carried out at courthouses, and other secure locations, for screening belonging at a security point.

Since these security screening trays are used scores if not hundreds of times a day at busy security check points, their failure to properly retain the screened items carry have several undesirable consequences, not least of which is delaying the flow of individuals being screened. Other consequences include the item falling out and being damaged from the fall or by being trampled by subsequent security screening trays or being damaged during the process of being retrieved. Moreover, such items can cause problems to the machinery of the screening process, be it to the conveyor component or to the screening devices, which can be expensive x-ray machines, computer tomography machines and similar devices.

Current security screen trays fail to keep odd-shaped or light weight items secured retained within the security screening trays during conveyance portion of the screening process.

As can be seen, there is a need for a retention system for a security screening tray, wherein the retention system retains the security screening tray's items during the screening process.

### SUMMARY OF THE INVENTION

In the United States more than 2 million people per day travel through transportation security administration checkpoints.

All the property of these 2 million people is screened through x-ray or computed tomography machines (CT). Baggage that is to be checked under the aircraft is screened using EDS machines, (explosive detection systems).

These machines work in a similar fashion. X-ray, CT, and EDS machines are used at many locations, including but not limited to: Airports, Federal Buildings, private businesses, night clubs, schools, border crossing, courthouses, and sports arenas. X-ray, CT, and EDS machines are used in the screening of goods coming into the country at border cargo locations and ports.

X-ray, CT, and EDS systems all emit radiation. To keep the users safe from this radiation there are often multiple sets of heavy leaded curtains that sweep closed and absorb radiation as an item is inspected. These heavy leaded curtains are in most cases the reason that items become dislodged or swept out of security trays. The security tray item retention system fixes that problem.

Items that are lightweight or oddly shaped can often be swept out of the security trays onto the belt inside of the machine. Valuable and important items such as passports licenses cash and jewelry can become lodged or lost within the system. Items such as electronics, cell phones, sunglasses, clothing, and musical instruments can be damaged if they are dislodged inside of the machine. Items that are dislodged or swept out of security trays can also damage the x-ray, CT, or EDS systems. The functioning of the screening machinery is critical for passenger flow and safety at airports.

When an item has been dislodged or swept out of a security tray into the machines must be shut down for a period for the items to be recovered and for the machines' status to be assessed. These shutdowns can affect passenger flow rate at airports.

The security tray item retention system has been developed in such a way to help expedite passengers through a TSA checkpoint, or any other security checkpoint that uses x-ray, CT, or EDS technology to screen items.

The security tray item retention system helps to ensure that valuable items such as passports identifications cash and jewelry stay safely within the confines of the security tray throughout the entire screening process. The security tray item retention system ensures that bags and luggage that may be a size or shape more prone to be coming dislodged from security trays stay firmly inside the tray.

Items like musical instruments, lightweight backpacks and duffel bags, pet carriers, or lightweight paper shopping bags. The security tray item retention system is designed in such a way to help expedite passengers and minimize the losses that are paid out for damaged or lost items by the transportation security administration, and the lost or damaged items that passengers have experienced.

The security tray item retention system is easily retrofitted to any tray currently in use with x-ray, CT, and EDS screening machines. The retention system can be integrated into new versions of Trays and installed during The security tray item retention system will consist of a few variations depending on the need of the end user. One embodiment of the present invention would utilize an elastic type of cargo net. The cargo net would cover a majority portion of the security tray. A method of securing could include a bolt holding P-clips to the security tray, around the upper rim of the tray, the P-clips would in turn hold the elastic type netting in place. By not covering the entire security tray this ensures that users of the tray can easily place items in and under the net and remove items from under the net when they are finished using the tray production.

Another embodiment of the retention system would be one using a nylon type webbing to cover a majority portion of the security tray fastened to the security tray along the upper and outer sidewall areas by snap button type fasteners. This would make the security tray item retention system removable and able to swap to other trays. The nylon webbing would have a female type of push snap button, and the male portion would be installed on the security tray itself.

Yet another embodiment of the security training retention system would be a nylon type webbing that would cover the entirety of the security tray. The upper outer sidewall portion of the security tray would have a strip of hook and loop fastener around the entire perimeter of the security tray. The nylon webbing would also have hook and loop fastener around its inner perimeter to completely hold the two pieces together. The nylon webbing would then be removed by the passenger or user to remove their items that were held securely inside.

Security trays could be manufactured in a way to be adaptable for this system. Trees could have fasteners or tabs to hold either elastic cargo net type or nylon webbing type onto the tray. The security tray item retention system embodied in the present invention keeps items inside of the security screening trays.

The security screening tray item retention system may be a permanent or semipermanent net system that is attached to security screening trays, wherein the net system is dimensioned and adapted for netting keeps items that would otherwise fall, or be pushed out of security screening trays, inside the security screening trays.

In one aspect of the present invention, a retention system for a security screening tray, the retention system includes the following: a netting having an array of longitudinal and latitudinal cords interfacing at nodes; attachment points spaced apart along two opposing peripheral edges of the security screening tray;

and for each peripheral edge, each attachment point slidably engages an edge cord of said array so that the edge cord is free to move in a direction parallel with a longitudinal axis of the edge cord, yet the edge cord is restrained at the attachment in two directions orthogonal to the parallel direction point.

In another aspect of the present invention, the above-mentioned retention system further includes wherein each attachment point comprises a loop clamp having a tube portion that slidably engages the edge cord, wherein the netting comprises cargo netting, wherein another peripheral edge of the of the security screening tray is spaced apart from an unattached edge of the netting by a setoff distance, wherein the setoff distance is approximately ten to thirty percent of a distance of one of the two opposing peripheral edges, wherein the netting comprises nylon strapping.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention.

FIG. 2 is a top plan view of an exemplary embodiment of the present invention.

FIG. 3 is an exploded perspective view of an exemplary embodiment of the present invention.

FIG. 4 is a detailed perspective view of an exemplary embodiment of the present invention, illustrating an attachment point.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a retention system of a security screening tray. The retention system embodies a netting that is fixed to a periphery of an opening of the security screening tray. The netting may be attached, by way of attachment points, on only two sides of the other rectangular perimeter of the opening.

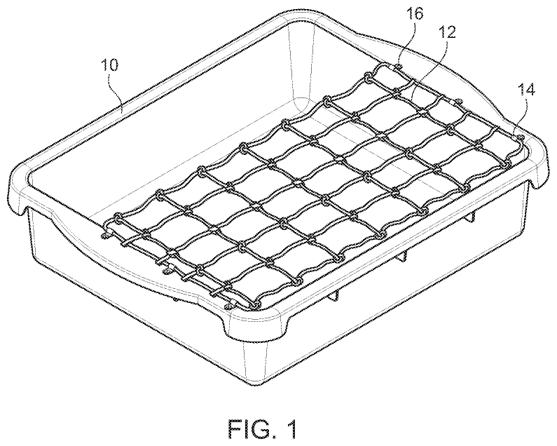

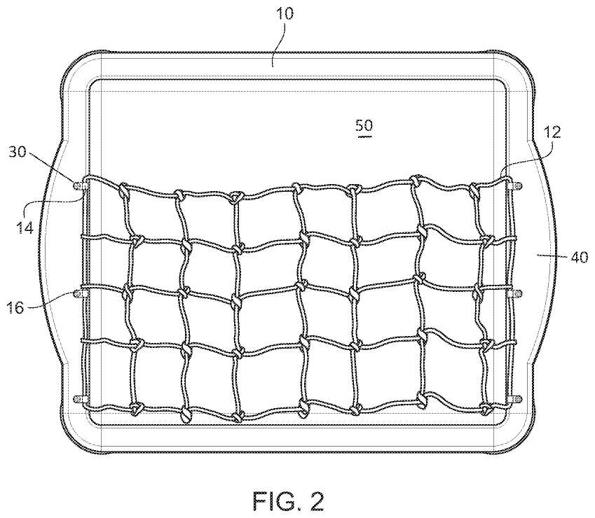

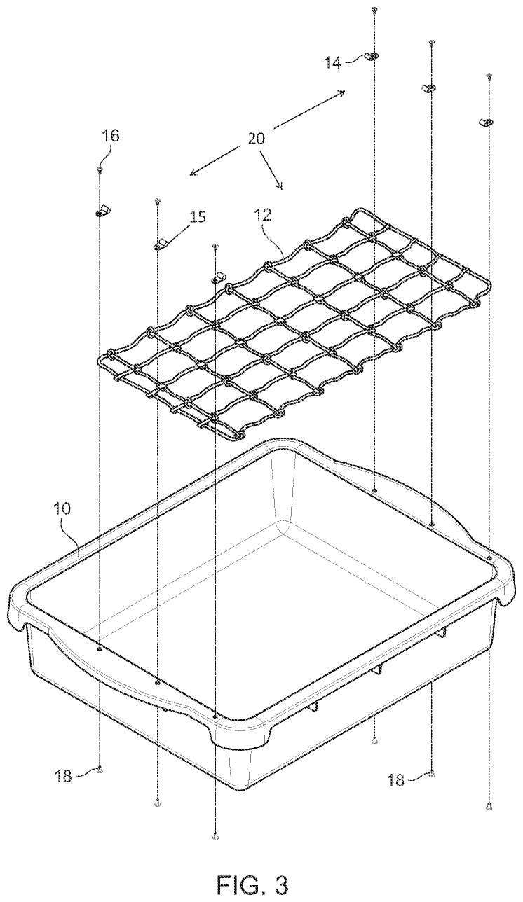

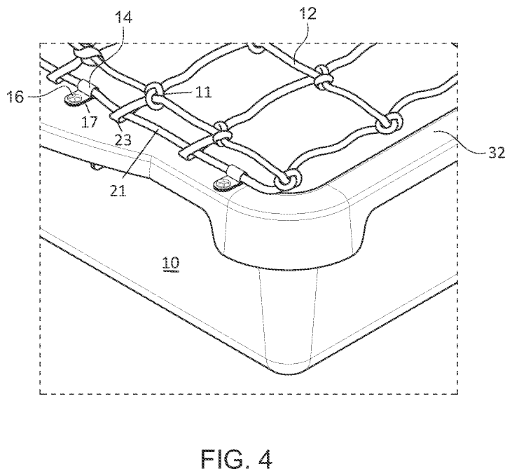

Referring the FIGS. 1 through 4, the present invention may include a security screening tray 10 with a retention system 20 operatively associated thereto. The retention system 20 may include an elastic netting 12 joined along an upper periphery of the security screening tray 10 by way of spaced apart attachment points 30.

Each attachment point 30 may include a loop clamp 14 and a first fastener 16 and a second fastener 18. The loop clamp 14 provides a conduit 15 through which an edge cord 23 of the netting 12 is collared. The first fastener 16 may interface with a tab 17 of the loop clamp 14 along a first side thereof, while the second fastener 18 interfaces with the tab 17 along a second side thereof, wherein the second side is opposite the first side. The first fastener 16 may be a bolt, an elongate threaded fastener, or other fastener that facilitates the attachment point as herein described and disclosed. The second fastener 18 may be a rivet nut, threaded insert, or other one-piece internally threaded and counterbored tubular element that can be anchored entirely from the second side by way of operatively associating with the first fastener 16.

The netting 12 may be cargo netting having an array of cords 13 providing longitudinal cords extending in a longitudinal direction and latitudinal cords extending in a latitudinal direction, orthogonal the longitudinal direction. The longitudinal and latitudinal cords engage at fixed nodes 11. The fixed nodes 11 provide a fixed engagement between the associated longitudinal and latitudinal cords 13. All cords 13 have sufficient elasticity to conform to items in the security screening tray 10 that they engage.

Along at least one edge of the netting 12 (defined by a latitudinal or longitudinal cord 13), an edge cord 23 passes through edge nodes 23 that are loops at the terminus of a cord 13, which enable the edge cord 23 and edge node 23 freedom of movement, relative to each other (as opposed to movement based on elastic deformation) in all directions, include along the x-axis, y-axis, and z-axis. In contrast, the fixed nodes 11 prevents movement in the x-axis and y-axis (i.e., longitudinal and latitudinal directions). This additional freedom of movement the attached edge of the retention system increases the tolerance of the netting 12 relative to the volume of items secured by the netting 12, while not compromising the ability of the netting 12 to prevent the items from getting through the spacing in the netting 12 or causing ultimate failure of the netting 12.

Likewise, the attachment points 30 are spaced apart along an upper periphery 32 of the security screening tray 10, to facilitate this tolerance and retention balance. The periphery 32 is understood to include the meets and bounds of the opening of the security screening tray 10 (that communicates to the storage space thereof) and may include associated structure further outward of said opening. The spaced apart relationship of attachment points 30 may be between approximately two to approximately six inches. Alternatively, the attachment points may be approximately every two edge nodes 21.

Moreover, the attachment points 30 may be disposed on only two opposing sides of the periphery of the security screening tray 10. More specifically, the two opposing sides may be the sides of the periphery 32 where handles 40 of the security screening tray 10 are disposed. In some embodiments, these opposing sides of the security screening tray 10 may be the opposing longitudinal ends, thereby affording the two unattached edges to be the longitudinal edges, whereby a user can place their items into the security screening tray 10 just outward of these unattached edges.

Furthermore, one unattached edge of the netting 12 of the retention system would be at an offset 50 inward of an associated edge of the security screening tray 10 periphery 32. This offset 50 may be spaced apart an associated edge of the periphery 32 by between ten to thirty percent of a distance defined by a distance between the associated edge and an opposing edge of the periphery 32. It should be noted in some embodiments, the netting 12 can cover the entire security screening tray 10 opening, depending on use and items that will be placed into the security screening tray 10.

The periphery 32 may include a flange of an upper rim of the security screening tray 10. The attachment points 30 may be connected to said upper rim flange. During manufacture of the present invention a user may drill multiple holes into this rime flange and insert the second fasteners 18 from the second side (e.g., the underside of the rim flange). Then the manufacturer may anchor the first fastener 16 in the second fastener 18 through the tab 17 of the loop clamps 14, which are already operatively associated with the relevant edge cords 23 of the netting 12.

In other embodiments, the cord-based netting 12 could be replaced with nylon strap style webbing. In some embodiment, a semi-permanent solution would replace the loop clamp 14, while the first and second fasteners 16 and 18 may be hook and loop fasteners.

During use, when loading the security screening tray 10 with items, the elastic netting would be raised by hand, and items placed underneath. the netting (or webbing) 12 will keep items inside of the security screening tray 10. When retrieving goods and items, a user would simply lift up the netting (or webbing) 12 and take their items out.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A retention system for a security screening tray, the retention system comprising:
a netting having an array of longitudinal and latitudinal cords interfacing at nodes;
attachment points spaced apart along two opposing peripheral edges of the security screening tray; and
for each peripheral edge, each attachment point slidably engages an edge cord of said array so that the edge cord is free to move in a direction parallel with a longitudinal axis of the edge cord, yet the edge cord is restrained at the attachment in two directions orthogonal to the parallel direction point.

2. The retention system of claim 1, wherein each attachment point comprises a loop clamp having a tube portion that slidably engages the edge cord.

3. The retention system of claim 1, wherein the netting comprises cargo netting.

4. The retention system of claim 1, wherein another peripheral edge of the of the security screening tray is spaced apart from an unattached edge of the netting by a setoff distance, wherein the setoff distance is approximately ten to thirty percent of a distance of one of the two opposing peripheral edges.

5. The retention system of claim 1, wherein the netting comprises nylon strapping.
